(19) United States
(12) Patent Application Publication
(10) Pub. No.: US 2026/0289699 A1
(43) Pub. Date: Sep. 24, 2026

(54) ARTIFICIAL INTELLIGENCE ENHANCED REAL ESTATE TRANSACTION PLATFORM WITH INTEGRATED PROPERTY SEARCH, LISTING INTELLIGENCE, AND AUTOMATED NEGOTIATION

(71) Applicants: Bryan Bryan Brewer, New Smyrna Beach, FL (US); Albert Bustamante, Winter Garden, FL (US)

(72) Inventors: Bryan Bryan Brewer, New Smyrna Beach, FL (US); Albert Bustamante, Winter Garden, FL (US)

(21) Appl. No.: 19/554,861

(22) Filed: Mar. 3, 2026

Related U.S. Application Data
(60) Provisional application No. 63/667,459, filed on Jul. 3, 2024.

(51) Int. Cl. G06Q 50/16

(52) U.S. Cl. CPC G06Q 50/16

(57) ABSTRACT

A system for facilitating real estate transactions comprising a platform with at least one processor and memory storing instructions to maintain a property database, provide a search interface that receives natural language queries from users and processes them using a first artificial intelligence model to determine property preferences and retrieve matching property listings, generate contextual property analyses for selected property listings using a second artificial intelligence model including valuation assessments and investment evaluations derived from market data, provide listing-level conversational interfaces associated with individual property listings for receiving and responding to natural language inquiries concerning properties, and execute automated negotiation sessions between buyer and seller users conducted by a negotiation engine.

### CROSS-REFERENCE TO RELATED APPLICATIONS

This application claims the benefit of U.S. Non-Provisional patent application Ser. No. 19/259,184, filed Jul. 3, 2025, entitled System and Method for Digital Negotiation and Execution of Real Estate Agreements, the entire contents of which are hereby incorporated by reference in their entirety.

### FIELD OF INVENTION

The present invention relates generally to computer-implemented real estate transaction systems, and more particularly to an integrated platform employing artificial intelligence models for natural language property search, per-listing contextual analysis and conversational assistance, and automated negotiation with confidential seller-defined parameters.

### BACKGROUND

The real estate industry has historically required consumers to navigate a fragmented ecosystem of disconnected platforms in order to complete a single transaction. A prospective buyer seeking to identify, evaluate, and ultimately acquire a property must typically engage with separate services for property search, market analysis, financing estimation, tour scheduling, and offer negotiation. Each of these interactions occurs through a different interface, operated by a different provider, and producing outputs that are not integrated with one another. The result is a transaction process characterised by inefficiency, information loss between stages, and a substantial cognitive burden on the consumer who must manually synthesise information gathered from disparate sources into a coherent basis for decision-making.

Existing property search platforms rely predominantly on filter-based search paradigms in which a user must specify discrete categorical inputs such as price range, bedroom count, property type, and geographic area. These rigid filter structures fail to capture the nuanced, multi-dimensional preferences that characterise real property search behaviour. A buyer seeking, for example, a family-friendly home near quality schools with natural light and a manageable commute cannot express these requirements through conventional filter selections without decomposing the inquiry into multiple separate searches and manually correlating the results. The gap between how consumers think about their property requirements and how existing platforms accept search input represents a fundamental limitation that reduces search effectiveness and extends the time required to identify suitable properties.

Once a consumer identifies a property of potential interest, the information available through existing platforms is typically limited to static listing data comprising photographs, a textual description authored by the listing agent, and basic property attributes. Absent from these presentations is any synthesised intelligence regarding the investment potential of the property, the relationship between the listing price and current market conditions for comparable properties, or an assessment of risk factors that may affect the value or desirability of the property over time. Consumers seeking this type of analytical information must independently research comparable sales data, rental market conditions, neighbourhood trends, and economic indicators from external sources, a process that requires both specialised knowledge and considerable time investment.

The negotiation phase of real estate transactions presents particular challenges arising from the inherently asynchronous and agent-mediated nature of the process. Conventional negotiations proceed through a sequence of offers and counter-offers communicated between buyer and seller agents, with each communication cycle potentially spanning hours or days. This process is dependent on the availability and responsiveness of human agents, introduces the possibility of miscommunication or strategic error, and creates information asymmetries that may disadvantage either party. Of particular concern is the protection of the seller's minimum acceptable price, which must remain confidential throughout the negotiation to preserve the seller's bargaining position, yet which must simultaneously guide the counter-offer strategy to move the negotiation toward a successful conclusion.

Real estate professionals face a parallel set of challenges arising from the fragmentation of their operational tools. An agent managing an active portfolio of listings, leads, and transactions must typically maintain separate systems for listing creation and management, client relationship management, lead tracking and follow-up, performance analytics, and marketing activities. The lack of integration among these tools produces duplicated data entry, inconsistent records, missed follow-up opportunities, and an inability to derive holistic insights from the agent's practice data. There exists a need for an integrated platform that addresses the limitations of existing systems across the full spectrum of real estate transaction activities, from initial property discovery through negotiation and beyond, for both consumer users and real estate professionals.

It is within this context that the present invention is provided.

### SUMMARY

In accordance with an embodiment of the present invention, there is provided a system comprising at least one processor, at least one memory coupled to said at least one processor, and a property database storing property listing data associated with a plurality of real estate properties. The system further comprises a search interface configured to receive a natural language query from a user and process said natural language query using a first artificial intelligence model to determine property preferences from said natural language query, and to retrieve from said property database a set of property listings matching said property preferences. The system further comprises a listing intelligence module configured to generate, for a selected property listing from said set of property listings, a contextual property analysis using a second artificial intelligence model, said contextual property analysis comprising at least a valuation assessment derived from market data and an investment evaluation associated with said selected property listing. The system further comprises a listing-level conversational interface associated with said selected property listing, said conversational interface configured to receive a natural language inquiry from a user concerning said selected property listing and to generate, using an artificial intelligence model, a response to said natural language inquiry based at least in part on said property listing data. The system further comprises a negotiation engine configured to receive from a seller user a set of seller-defined negotiation parameters comprising at least a confidential reserve price, to receive from a buyer user a transaction offer associated with said selected property listing, to generate using an artificial intelligence model a counter-offer based at least in part on said seller-defined negotiation parameters, said transaction offer, and market data associated with said selected property listing, and to transmit said counter-offer to said buyer user without disclosing said confidential reserve price.

In some embodiments, the negotiation engine is further configured to generate a success probability score indicating a likelihood that the buyer user will accept a counter-offer at or above the confidential reserve price, said success probability score derived at least in part from an analysis of a negotiation pattern of said buyer user during said automated negotiation session.

In some embodiments, the negotiation engine is further configured to generate a predicted acceptance range indicating a range of transaction values within which said buyer user is predicted to accept an offer, said predicted acceptance range based at least in part on said transaction offer, one or more prior offers received from the buyer user during said automated negotiation session, and comparable transaction data.

In some embodiments, the automated negotiation session comprises a plurality of negotiation rounds, each negotiation round comprising receiving a further transaction offer from the buyer user and generating a further counter-offer, wherein the negotiation engine adjusts a counter-offer strategy based on a progression of offers received across said plurality of negotiation rounds.

In some embodiments, the negotiation engine presents a first interface to the buyer user and a second interface to the seller user, the first interface comprising a conversational negotiation view displaying communications exchanged during the automated negotiation session, and the second interface comprising a strategy dashboard displaying the confidential reserve price, a current transaction offer from the buyer user, a difference between said current transaction offer and said confidential reserve price, a recommended counter-offer, and said success probability score.

In some embodiments, the counter-offer generated by the negotiation engine references at least one of a property feature of said selected property listing and a comparable sale associated with a geographic area of said selected property listing.

In some embodiments, the negotiation engine employs a plurality of artificial intelligence models comprising at least two distinct model architectures to generate said counter-offer.

In some embodiments, the listing intelligence module is further configured to generate a return-on-investment assessment for said selected property listing based at least in part on historical market data and rental rate data associated with a geographic area of said selected property listing.

In some embodiments, the listing-level conversational interface is further configured to schedule a property tour by interfacing with an agent management module to coordinate availability between the user and a listing agent associated with said selected property listing.

In some embodiments, the listing-level conversational interface presents a plurality of pre-populated query options contextually generated based on property listing data associated with said selected property listing.

In some embodiments, the search interface is further configured to present, concurrently with said natural language query capability, a filter-based search comprising at least one of a geographic map display with interactive property markers, a price range selector, and property attribute filters.

In some embodiments, the search interface presents said set of property listings as a plurality of listing cards, each listing card comprising property summary data and a selectable element configured to invoke said listing-level conversational interface for a corresponding property listing.

In some embodiments, the system further comprises an agent interface module accessible to a real estate professional user, said agent interface module comprising at least a listing management module for creating and managing property listings in said property database and a lead management module for tracking prospective buyer or tenant users.

In some embodiments, the agent interface module further comprises a performance dashboard displaying at least one of an active listing count, an active lead count, a transaction volume metric, and a goal progress indicator.

### BRIEF DESCRIPTION OF THE DRAWINGS

Various embodiments of the invention are disclosed in the following detailed description and accompanying drawings.

FIG. 1 illustrates an example system architecture of a real estate transaction platform in accordance with an embodiment of the present invention.

FIG. 2 illustrates an example flowchart depicting an automated negotiation session executed by a negotiation engine in accordance with an embodiment of the present invention.

FIG. 3 illustrates an example schematic representation of a dual-view negotiation interface in accordance with an embodiment of the present invention.

FIG. 4 illustrates an example flowchart depicting a property listing intelligence flow in accordance with an embodiment of the present invention.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the terms “a” and “an” are intended to denote at least one of a particular element. As used herein, the term “comprising” is intended to be open-ended, meaning that additional elements or steps beyond those explicitly recited may be present. The term “or” as used herein is intended to be inclusive, meaning “and/or” unless the context clearly indicates otherwise. As used herein, the term “module” refers to a software component, a hardware component, or a combination of software and hardware components configured to perform a specified function. A module may be implemented as executable code stored in memory and executed by a processor, as a dedicated hardware circuit, as a field-programmable gate array configuration, or as any suitable combination thereof.

The term “artificial intelligence model” as used herein refers to a computational model trained on data to perform inference tasks including, but not limited to, natural language understanding, natural language generation, classification, prediction, recommendation, and analysis. An artificial intelligence model may comprise a large language model, a transformer-based neural network, a recurrent neural network, a convolutional neural network, a generative adversarial network, a reinforcement learning model, an ensemble of multiple model architectures, or any other machine learning architecture suitable for the described function. In one example implementation, an artificial intelligence model may comprise a pre-trained large language model such as those based on the GPT, Claude, Gemini, or similar architectures, optionally fine-tuned on domain-specific training data. In another example implementation, an artificial intelligence model may comprise a purpose-built model trained from initialisation on domain-specific data. References herein to a “first artificial intelligence model,” a “second artificial intelligence model,” and “an artificial intelligence model” are intended to encompass embodiments in which these are the same model instance serving multiple functions, different instances of the same model architecture, or entirely different model architectures, unless a specific distinction is stated.

The term “natural language query” as used herein refers to an input expressed in human language, whether in complete sentence form, phrase form, keyword form, or any combination thereof. A natural language query is distinguished from a structured query in that it does not require the user to conform to a predefined syntax, vocabulary, or input format, although a natural language query may incidentally include structured elements. The natural language query may be expressed in any human language and may be received as text input, as speech input converted to text through speech recognition, or through any other input mechanism that produces a natural language representation of the user's intent.

The term “property listing data” as used herein refers to data associated with a real estate property that is listed or has been listed for sale, lease, or rent on the platform. Property listing data includes, but is not limited to, property attribute data describing physical characteristics of the property, location data identifying the geographic position and address of the property, financial data including listing price and transaction history, media data including photographs and virtual tour assets, status data indicating the current listing status, and agent association data identifying one or more real estate professionals associated with the listing.

The term “contextual property analysis” as used herein refers to an analytical output generated by an artificial intelligence model that synthesises information from multiple data sources to provide an evaluation of a property listing within the context of current market conditions, comparable transactions, and investment considerations. A contextual property analysis is distinguished from a mere aggregation of data points in that the analysis involves inference, comparison, and evaluative judgment performed by the artificial intelligence model rather than simple retrieval and display of raw data. A contextual property analysis comprises at least a valuation assessment and an investment evaluation, and may further comprise risk assessments, neighbourhood evaluations, trend analyses, and actionable recommendations.

The term “valuation assessment” as used herein refers to an analysis of the monetary value of a real estate property relative to market conditions and comparable properties. A valuation assessment may include comparison of the listing price to estimated market value, analysis of price per square foot relative to comparable properties, identification of pricing trends in the geographic area, and evaluation of whether the property appears to be priced at, above, or below current market value. A valuation assessment is not a formal appraisal and is not intended to serve as a substitute for a professional appraisal conducted by a licensed appraiser, but rather provides an informational analysis to assist the user in evaluating the property.

The term “investment evaluation” as used herein refers to an analysis of the financial characteristics of a real estate property from the perspective of an investor or prospective owner. An investment evaluation may include one or more of a return-on-investment assessment, a rental income projection, a cash flow analysis, a capitalization rate estimate, and a risk evaluation. The investment evaluation considers factors including, but not limited to, potential appreciation or depreciation, rental market conditions, carrying costs, tax implications, and market risk factors relevant to the geographic area and property type.

The term “confidential reserve price” as used herein refers to a monetary value established by a seller user that represents the minimum transaction value the seller user is willing to accept for a property listing. The confidential reserve price is stored securely within the system and is accessible only to the seller user and to system components authorised to process negotiation logic. The confidential reserve price is not disclosed to the buyer user, is not derivable from communications transmitted to the buyer user, and is not displayed in any interface accessible to the buyer user. The confidential reserve price may be established as an absolute monetary value, as a percentage of the listing price, or as a formula-derived value based on market data, and may be modified by the seller user at any time during or between negotiation sessions.

The term “seller-defined negotiation parameters” as used herein refers to a set of configuration values established by the seller user or a real estate professional user acting on behalf of the seller user that govern the behaviour of the negotiation engine during an automated negotiation session. Seller-defined negotiation parameters comprise at least a confidential reserve price and may further comprise a preferred closing timeline, acceptable contingency types, included or excluded personal property items, maximum negotiation round limits, maximum negotiation time limits, and any other parameters that constrain or guide the negotiation strategy employed by the negotiation engine.

The term “automated negotiation session” as used herein refers to a computer-mediated negotiation process conducted between a buyer user and a seller user in which at least the seller-side negotiation communications are generated by the negotiation engine using one or more artificial intelligence models, without requiring real-time human input from the seller user or a human agent during individual negotiation rounds. An automated negotiation session may comprise a single negotiation round or a plurality of negotiation rounds, and may conclude with acceptance of an offer, rejection of an offer, expiration of a negotiation time or round limit, or withdrawal by either party.

The term “counter-offer” as used herein refers to a response generated by the negotiation engine in reply to a transaction offer from the buyer user, said response comprising at least a proposed transaction value that differs from the buyer user's most recent offer and a natural language communication conveying the counter-offer to the buyer user. A counter-offer may further include proposed modifications to non-price terms such as closing timeline, contingencies, or included items.

The term “transaction offer” as used herein refers to a communication from the buyer user proposing terms for a real estate transaction with respect to a property listing. A transaction offer comprises at least a proposed transaction value representing the monetary amount the buyer user is willing to pay or accept, and may further comprise proposed contingencies, a proposed closing date, a financing indication, and additional terms or conditions.

The term “listing-level conversational interface” as used herein refers to a conversational interface that is scoped to a specific property listing, such that the conversational context, the data accessed by the underlying artificial intelligence model, and the responses generated are specific to the property listing with which the interface is associated. A listing-level conversational interface is distinguished from a general-purpose chatbot or virtual assistant in that it operates with access to and awareness of the property listing data, market data, and contextual information specific to the associated property.

The term “success probability score” as used herein refers to a numerical value, typically expressed as a percentage, indicating the estimated likelihood that a buyer user will accept a counter-offer at or above the confidential reserve price during an automated negotiation session. The success probability score is generated by the negotiation engine based on analysis of negotiation dynamics including the buyer user's offer history, the rate and direction of offer movement, responsiveness to specific argument types, and statistical patterns derived from historical negotiation data.

The term “predicted acceptance range” as used herein refers to a range of transaction values within which the buyer user is estimated to accept an offer during an automated negotiation session. The predicted acceptance range is expressed as a lower bound and an upper bound defining a value interval and is generated by the negotiation engine based on the buyer user's offer history, comparable transaction data, and negotiation pattern analysis.

The term “market data” as used herein refers to information concerning real estate market conditions, property values, transaction histories, and related economic indicators. Market data includes, but is not limited to, recent comparable sale records, rental rate data, inventory levels, days-on-market statistics, price trend indices, neighbourhood demographic data, school ratings, crime statistics, zoning information, and planned development data.

The term “real estate professional user” as used herein refers to a user of the platform who operates in a professional capacity within the real estate industry, including but not limited to licensed real estate agents, real estate brokers, property managers, real estate developers, and real estate investment professionals.

The term “real estate transaction” as used herein refers broadly to any transaction involving the transfer of rights in real property, including but not limited to the purchase and sale of residential property, the purchase and sale of commercial property, the leasing of residential or commercial property, short-term rental arrangements, and any other transaction type in which a party acquires rights to occupy, use, or own real property. Unless the context clearly indicates otherwise, references to real estate transactions herein are intended to encompass all such transaction types and are not limited to any single transaction category.

Unless expressly stated otherwise, words such as “a,” “an,” and “the” are intended to include both singular and plural forms, and the term “about” is intended to accommodate plus or minus ten percent variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

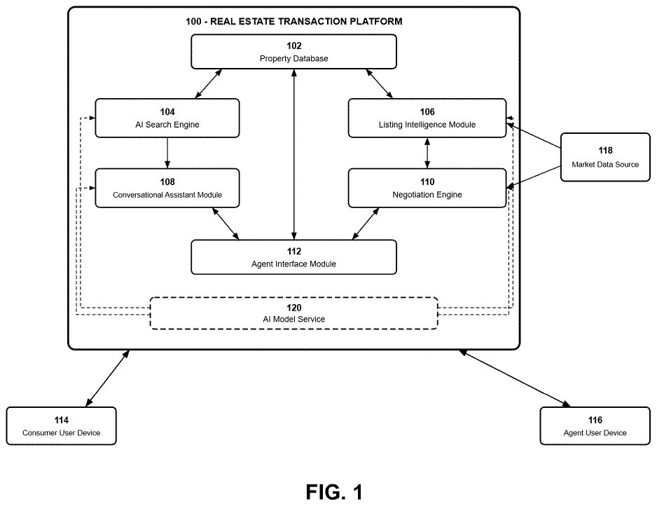

FIG. 1 illustrates an example system architecture of a real estate transaction platform 100 in accordance with an embodiment of the present invention. The platform 100 is implemented as a cloud-based computing infrastructure comprising at least one processor and at least one memory storing instructions that, when executed by the at least one processor, cause the system to perform the operations described herein. The platform 100 may in some examples be deployed across a plurality of server instances operating in a distributed computing environment, with individual functional modules hosted on dedicated servers, shared servers, or serverless computing resources as appropriate to the performance and scalability requirements of the deployment. The platform 100 may alternatively be implemented as an on-premises system, a hybrid cloud and on-premises system, or any other suitable computing architecture.

The platform 100 comprises a property database 102 serving as a central data repository for property listing data associated with a plurality of real estate properties. The property database 102 stores, for each property listing, property attribute data describing physical characteristics of the property including but not limited to square footage, bedroom count, bathroom count, lot size, year built, construction materials, and amenity features. The property database 102 further stores location data identifying the geographic position and address of each property, financial data including listing price and transaction history, media data including photographs, video content, and virtual tour assets, status data indicating whether a listing is active, pending, sold, or withdrawn, and agent association data identifying one or more real estate professionals associated with the listing. The property database 102 may be implemented using a relational database management system, a document-oriented database, a graph database, a combination of database architectures, or any other data storage technology suitable for the volume and query patterns of the stored data. The property database 102 may receive property listing data from external data feeds including multiple listing service feeds, public property records, and direct agent input through the agent interface module 112.

The platform 100 comprises an AI search engine 104 configured to receive a natural language query from a user and process said natural language query using a first artificial intelligence model to determine property preferences from said natural language query. The AI search engine 104 extracts structured search parameters from unstructured natural language input, translating user intent expressed in conversational form into query criteria that can be executed against the property database 102. In operation, a user may submit a natural language query such as “find me a three-bedroom family home near good schools in a quiet neighbourhood under four hundred thousand dollars,” and the AI search engine 104 will parse this input to identify explicit preferences including bedroom count, proximity to schools, neighbourhood character, and maximum price, as well as implicit preferences that may be inferred from the query context such as property type, lot characteristics, and neighbourhood demographics. The AI search engine 104 retrieves from the property database 102 a set of property listings matching said property preferences, scores the retrieved listings by relevance across multiple weighted dimensions, and assembles a ranked result set for presentation to the user. The AI search engine 104 presents search results through a dual-mode interface comprising a natural language search capability and a concurrent filter-based search interface. The filter-based search interface may include a geographic map display with interactive property markers, a price range selector, property attribute filters for bedroom count, bathroom count, square footage, property type, and other attributes, and sorting options. The search results are presented as a plurality of listing cards, each listing card comprising property summary data including a representative image, listing price, bedroom and bathroom count, square footage, location, listing status, and time on market, and a selectable element configured to invoke the listing-level conversational interface for the corresponding property listing. The selectable element may be labelled “Ask AI” or with any other suitable label or icon that communicates the availability of the conversational interface. Listing cards may be presented in a list arrangement, a grid arrangement, a map overlay arrangement, or any combination thereof.

The platform 100 comprises a listing intelligence module 106 configured to generate, for a selected property listing from said set of property listings, a contextual property analysis using a second artificial intelligence model. The listing intelligence module 106 retrieves property listing data from the property database 102 and market data from a market data source 118, and processes this information through the second artificial intelligence model to produce an analytical output that synthesises multiple data dimensions into a coherent property evaluation. The contextual property analysis comprises at least a valuation assessment and an investment evaluation. The valuation assessment analyses the listing price relative to comparable properties in the geographic area, evaluates price per square foot against local benchmarks, identifies pricing trends over time, and determines whether the property appears to be priced at, above, or below current market value. The investment evaluation analyses the financial characteristics of the property from the perspective of a prospective owner or investor, and may include a return-on-investment assessment based on historical market data, a rental income projection based on rental rate data for the geographic area, a cash flow analysis, a capitalization rate estimate, and a risk evaluation identifying both positive factors such as below-market pricing, strong rental demand, or planned development in the area, and negative factors such as price premium relative to comparables, declining market trends, or high carrying costs. The listing intelligence module 106 generates its output as a natural language summary that synthesises the analytical findings into a format accessible to non-expert users while retaining sufficient detail to support informed decision-making.

The platform 100 comprises a conversational assistant module 108 configured to provide a listing-level conversational interface associated with a selected property listing. The conversational assistant module 108 initialises a conversational session that is scoped to the specific property listing, such that the conversational context, the data accessed by the underlying artificial intelligence model, and the responses generated are specific to the associated property. The conversational assistant module 108 presents to the user an introductory message identifying itself as a property-specific AI assistant and displays a plurality of pre-populated query options contextually generated based on the property listing data associated with the selected property listing. Pre-populated query options may include options for scheduling a property tour, inquiring about neighbourhood characteristics, asking about price negotiability or listing history, and checking property availability, and may further include contextual options specific to the property type, status, or features, such as inquiries about pool maintenance costs for a property with a pool, homeowners association fees for a property in a managed community, or renovation potential for a property listed as a fixer-upper. The user may select a pre-populated query option or compose an original natural language inquiry. The conversational assistant module 108 generates, using an artificial intelligence model, a response to said natural language inquiry based at least in part on said property listing data and market data, presenting the response as informative, property-specific, conversational natural language prose. The conversational assistant module 108 may further perform actions in response to user inquiries, including scheduling a property tour by interfacing with the agent interface module 112 to coordinate availability between the user and a listing agent associated with the property, generating a financing estimate including estimated monthly payments based on current interest rates and user-supplied parameters, and providing neighbourhood information including school ratings, amenity proximity, transportation access, and demographic data.

The platform 100 comprises a negotiation engine 110 configured to execute automated negotiation sessions between a buyer user and a seller user with respect to a selected property listing. The negotiation engine 110 receives from a seller user, through the agent interface module 112, a set of seller-defined negotiation parameters comprising at least a confidential reserve price. The confidential reserve price represents the minimum transaction value the seller user is willing to accept and is stored securely within the system such that it is accessible only to the seller user, to a real estate professional user acting on behalf of the seller user, and to system components authorised to process negotiation logic. The confidential reserve price is not disclosed to the buyer user, is not derivable from communications transmitted to the buyer user, and is not displayed in any interface accessible to the buyer user. The seller-defined negotiation parameters may further comprise a preferred closing timeline, acceptable contingency types, included or excluded personal property items, maximum negotiation round limits, maximum negotiation time limits, and pre-authorisation settings specifying whether the negotiation engine may automatically accept offers meeting the reserve price or whether seller confirmation is required. The negotiation engine 110 receives from a buyer user a transaction offer comprising at least a proposed transaction value and optionally comprising proposed contingencies, a proposed closing date, financing indication, and additional terms. The negotiation engine 110 retrieves market data from the market data source 118 including comparable sales, inventory levels, days-on-market statistics, and price trends for the geographic area of the property listing. The negotiation engine 110 evaluates the transaction offer against the seller-defined negotiation parameters and the market data, and determines whether the offer meets or exceeds the confidential reserve price. If the offer meets or exceeds the confidential reserve price, the negotiation engine 110 may accept the transaction, either automatically pursuant to seller pre-authorisation settings or after obtaining seller confirmation through the second interface. If the offer does not meet the confidential reserve price, the negotiation engine 110 generates, using an artificial intelligence model, a counter-offer based at least in part on said seller-defined negotiation parameters, said transaction offer, and market data associated with said selected property listing. The counter-offer comprises at least a proposed transaction value that differs from the buyer user's most recent offer and a natural language communication conveying the counter-offer to the buyer user with substantive justification referencing at least one of a property feature of said selected property listing and a comparable sale associated with the geographic area. The negotiation engine 110 transmits said counter-offer to said buyer user without disclosing said confidential reserve price. The negotiation engine 110 is further configured to generate a success probability score indicating a likelihood that said buyer user will accept a counter-offer at or above said confidential reserve price, said success probability score derived at least in part from an analysis of a negotiation pattern of said buyer user during said automated negotiation session, including the rate and direction of offer movement, responsiveness to specific argument types, and statistical patterns derived from historical negotiation data. The negotiation engine 110 is further configured to generate a predicted acceptance range indicating a range of transaction values within which said buyer user is predicted to accept an offer, said predicted acceptance range expressed as a lower bound and an upper bound defining a value interval. The negotiation engine 110 presents a first interface to the buyer user and a second interface to the seller user. The first interface comprises a conversational negotiation view displaying communications exchanged during the automated negotiation session in a chronological chat-style format. The second interface comprises a strategy dashboard displaying the confidential reserve price, a current transaction offer from the buyer user, a difference between said current transaction offer and said confidential reserve price, a recommended counter-offer, the success probability score, and the predicted acceptance range. The automated negotiation session may comprise a plurality of negotiation rounds, each negotiation round comprising receiving a further transaction offer from the buyer user and generating a further counter-offer, wherein the negotiation engine 110 adjusts a counter-offer strategy based on a progression of offers received across said plurality of negotiation rounds, including adjustments to the counter-offer value, the argumentative approach, and non-price concessions based on the trajectory of the negotiation.

The platform 100 comprises an agent interface module 112 providing a comprehensive set of tools for real estate professional users. The agent interface module 112 comprises a listing management module for creating and managing property listings in the property database 102, a lead management module for tracking prospective buyer or tenant users, and a performance dashboard displaying metrics including an active listing count, an active lead count, a transaction volume metric, and a goal progress indicator. The agent interface module 112 may further comprise social networking functionality enabling agents to connect with other agents and industry professionals, marketing tools for promoting listings, and calendar and scheduling functionality for managing property showings and client meetings. The agent interface module 112 is accessible through a dedicated interface presented on an agent user device 116.

A consumer user device 114 represents a computing device through which a consumer user accesses the platform 100. The consumer user device 114 may be a smartphone, a tablet computer, a laptop computer, a desktop computer, or any other computing device equipped with a display, an input mechanism, and network connectivity. A consumer user interacts with the AI search engine 104, the listing intelligence module 106, the conversational assistant module 108, and the buyer-facing interface of the negotiation engine 110 through the consumer user device 114.

An agent user device 116 represents a computing device through which a real estate professional user accesses the platform 100. The agent user device 116 may be any computing device as described with respect to the consumer user device 114. A real estate professional user interacts with the agent interface module 112 and the seller-facing interface of the negotiation engine 110 through the agent user device 116.

A market data source 118 represents one or more external data providers supplying market data to the platform 100. The market data source 118 may include multiple listing service data feeds, public property records and tax assessment databases, real estate analytics providers, school rating services, demographic data providers, crime statistics databases, zoning and land use databases, and planned development registries. The market data source 118 supplies data to the listing intelligence module 106 for use in generating contextual property analyses and to the negotiation engine 110 for use in generating counter-offers with market-informed justification.

An AI model service 120 represents the artificial intelligence inference infrastructure that provides AI model capabilities to the functional modules of the platform 100. The AI model service 120 provides inference services to the AI search engine 104, the listing intelligence module 106, the conversational assistant module 108, and the negotiation engine 110. The AI model service 120 may host a single artificial intelligence model serving multiple functions, multiple instances of the same model architecture each configured for a specific function, or a plurality of distinct model architectures each optimised for different tasks. The AI model service 120 supports multi-model orchestration in which a plurality of artificial intelligence models comprising at least two distinct model architectures collaborate to generate outputs, with different models handling different aspects of a task such as intent classification, information retrieval, response generation, and quality assessment. The AI model service 120 may utilise cloud-based inference services, on-premises inference hardware, edge computing resources, or any combination thereof.

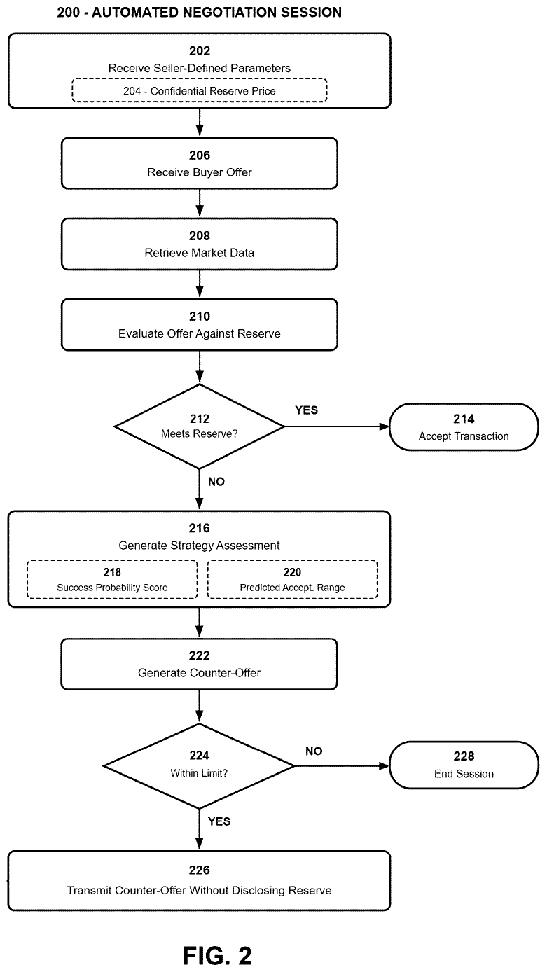

FIG. 2 illustrates an example flowchart depicting an automated negotiation session 200 executed by the negotiation engine 110 in accordance with an embodiment of the present invention. The flowchart illustrates the sequential and decision-based operations performed by the negotiation engine 110 during a single automated negotiation session between a buyer user and a seller user with respect to a selected property listing.

At step 202, the negotiation engine 110 receives seller-defined negotiation parameters from a seller user through the agent interface module 112. The seller-defined negotiation parameters comprise at least a confidential reserve price 204 representing the minimum transaction value the seller user is willing to accept. The seller-defined negotiation parameters may further comprise closing timeline preferences, acceptable contingency types, item inclusions or exclusions, round limits, time limits, and pre-authorisation settings as described with respect to FIG. 1. The seller user or a real estate professional user acting on the seller's behalf configures these parameters through the second interface of the negotiation engine 110, which may present default values based on the listing price and market conditions, with the seller user retaining full authority to modify any parameter. The confidential reserve price 204 is stored securely and is not accessible to the buyer user through any system interface or communication.

At step 206, the negotiation engine 110 receives a transaction offer from the buyer user. The transaction offer comprises at least a proposed transaction value representing the monetary amount the buyer user is offering for the property, and may further comprise proposed contingencies such as financing, inspection, or appraisal contingencies, a proposed closing date, a financing indication identifying the buyer's intended financing method, and additional terms or conditions. The buyer user submits the transaction offer through the first interface of the negotiation engine 110, which presents a conversational view through which the buyer user may communicate offers and receive responses in a natural language dialogue format.

At step 208, the negotiation engine 110 retrieves market data from the market data source 118 relevant to the property listing and the geographic area. The retrieved market data includes comparable sale records, current inventory levels, days-on-market statistics, price trend data, and other market indicators that inform the negotiation strategy. The market data retrieval at step 208 may occur upon receipt of each new offer such that the negotiation strategy is informed by the most current market conditions available.

At step 210, the negotiation engine 110 evaluates the transaction offer against the confidential reserve price 204 and the market data retrieved at step 208. The evaluation considers the proposed transaction value relative to the reserve price, the overall terms of the offer including contingencies and closing timeline, and the current market context. The evaluation at step 210 produces a comprehensive assessment of the offer that informs the subsequent decision logic.

At decision step 212, the negotiation engine 110 determines whether the transaction offer meets or exceeds the confidential reserve price 204. If the proposed transaction value meets or exceeds the confidential reserve price 204, the process proceeds to step 214. If the proposed transaction value is below the confidential reserve price 204, the process proceeds to step 216.

At step 214, the negotiation engine 110 accepts the transaction, concluding the automated negotiation session successfully. Depending on the seller pre-authorisation settings configured at step 202, the acceptance may be automatic or may require explicit confirmation from the seller user through the second interface. Upon acceptance, both the buyer user and the seller user receive notification of the agreed terms, and the system may initiate downstream transaction processes such as document generation, escrow coordination, or agent notification.

At step 216, the negotiation engine 110 generates a strategy assessment comprising analytical outputs that inform the counter-offer strategy. The strategy assessment includes a success probability score 218 indicating the estimated likelihood that the buyer user will accept a counter-offer at or above the confidential reserve price 204, derived from analysis of the buyer user's offer pattern, rate of offer movement, responsiveness to specific argument types employed in previous rounds, and statistical patterns derived from historical negotiation data across prior sessions. The strategy assessment further includes a predicted acceptance range 220 indicating a range of transaction values within which the buyer user is estimated to accept an offer, expressed as a lower bound and an upper bound defining a value interval, based on the buyer user's offer history, comparable transaction data, and negotiation trajectory analysis. The strategy assessment outputs 218 and 220 are displayed to the seller user through the second interface and are used by the negotiation engine 110 to calibrate the counter-offer generated at the subsequent step.

At step 222, the negotiation engine 110 generates a counter-offer using an artificial intelligence model. The counter-offer comprises a proposed transaction value strategically positioned to move the negotiation toward the confidential reserve price 204 at a pace the buyer user is assessed as likely to accept, and a natural language communication providing substantive justification for the counter-offer amount. The justification references at least one of a property feature of the selected property listing and a comparable sale associated with the geographic area, providing the buyer user with market-informed reasoning rather than an unsupported price demand. The artificial intelligence model generates the counter-offer considering the seller-defined negotiation parameters, the buyer user's current and prior offers, the market data, and the strategy assessment generated at step 216.

At decision step 224, the negotiation engine 110 determines whether the automated negotiation session remains within configured round and time limits. If the session is within limits, the process proceeds to step 226. If the session has reached its maximum round count or exceeded its time limit, the process proceeds to step 228.

At step 226, the negotiation engine 110 transmits the counter-offer to the buyer user through the first interface without disclosing the confidential reserve price 204. The buyer user receives the counter-offer as a natural language communication within the conversational negotiation view, presented as a response from a knowledgeable negotiation counterpart. The process then returns to step 206 to receive the buyer user's next transaction offer, initiating a further negotiation round. In subsequent rounds, the negotiation engine 110 adjusts its counter-offer strategy based on the progression of offers received across the plurality of negotiation rounds, including adjustments to counter-offer values, argumentative approaches emphasising different property features or market data, and flexibility on non-price terms.

At step 228, the negotiation engine 110 ends the negotiation session, generating a summary of the negotiation for both parties. The session may conclude with an option for the seller user to extend the negotiation by modifying the round or time limits, to adjust the confidential reserve price 204, or to contact the buyer user through alternative channels. The buyer user receives notification that the automated negotiation session has concluded.

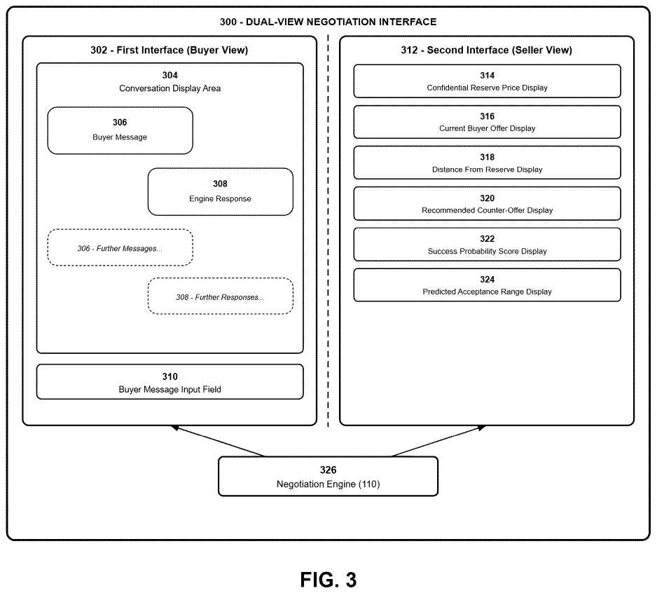

FIG. 3 illustrates an example schematic representation of a dual-view negotiation interface 300 in accordance with an embodiment of the present invention. The dual-view negotiation interface 300 illustrates the concurrent presentation of distinct interfaces to the buyer user and the seller user during an automated negotiation session, with both interfaces connected through and managed by the negotiation engine 110.

A first interface 302 is presented to the buyer user and comprises a conversational negotiation view through which the buyer user engages with the automated negotiation session. The first interface 302 contains a conversation display area 304 showing a chronological sequence of communications exchanged during the negotiation session. Within the conversation display area 304, buyer messages 306 are displayed with a first visual treatment such as left alignment and a first background colour or avatar indication, and negotiation engine responses 308 are displayed with a second visual treatment such as right alignment and a contrasting background colour or avatar indication, producing a chat-style exchange format familiar to users of messaging applications. The conversation display area 304 is scrollable to accommodate multi-round negotiation sessions and may display timestamps, typing indicators, and read receipts. The first interface 302 further comprises a buyer message input field 310 through which the buyer user composes and submits natural language messages including offers, questions, responses to counter-offers, and general inquiries about the negotiation or the property. The buyer message input field 310 may support document attachment functionality enabling the buyer user to submit supporting documents such as pre-approval letters or proof of funds. The buyer user experiences the negotiation as a dialogue with a knowledgeable negotiation counterpart.

A second interface 312 is presented to the seller user and comprises a strategy dashboard providing comprehensive visibility into the negotiation dynamics. The second interface 312 displays a confidential reserve price display 314 showing the seller's configured reserve price as a persistent reference point. A current buyer offer display 316 shows the most recent transaction offer received from the buyer user. A distance from reserve display 318 shows the numerical difference between the current buyer offer and the confidential reserve price, which may be presented as an absolute value, a percentage, a colour-coded progress bar or indicator transitioning from red through amber to green as the buyer's offers approach the reserve price, or any combination of these representations. A recommended counter-offer display 320 shows the counter-offer recommended by the negotiation engine 110, which the seller user may approve as presented, modify before transmission, or override entirely, unless the seller user has configured pre-authorisation settings permitting the negotiation engine 110 to transmit counter-offers automatically. A success probability score display 322 shows the estimated likelihood that the buyer user will accept a counter-offer at or above the confidential reserve price, presented as a percentage with a colour-coded scale. A predicted acceptance range display 324 shows the estimated range of transaction values within which the buyer user is predicted to accept an offer, presented as a value interval with an explanatory note regarding the analytical basis for the estimate.

A negotiation engine indicator 326 represents the negotiation engine 110 positioned at the centre of the dual-view interface, illustrating its role as the intermediary that processes buyer messages, generates negotiation engine responses 308 for display in the first interface 302, and updates all strategy dashboard metrics 314 through 324 in the second interface 312 in real time as the negotiation progresses. The negotiation engine 326 maintains a unified negotiation state ensuring that buyer-facing communications and seller-facing analytics are consistent and derived from the same underlying strategic logic. The seller user has full visibility of the strategy assessment and analytical outputs throughout the negotiation while the buyer user has no access to the seller's parameters, strategy assessment, or dashboard analytics.

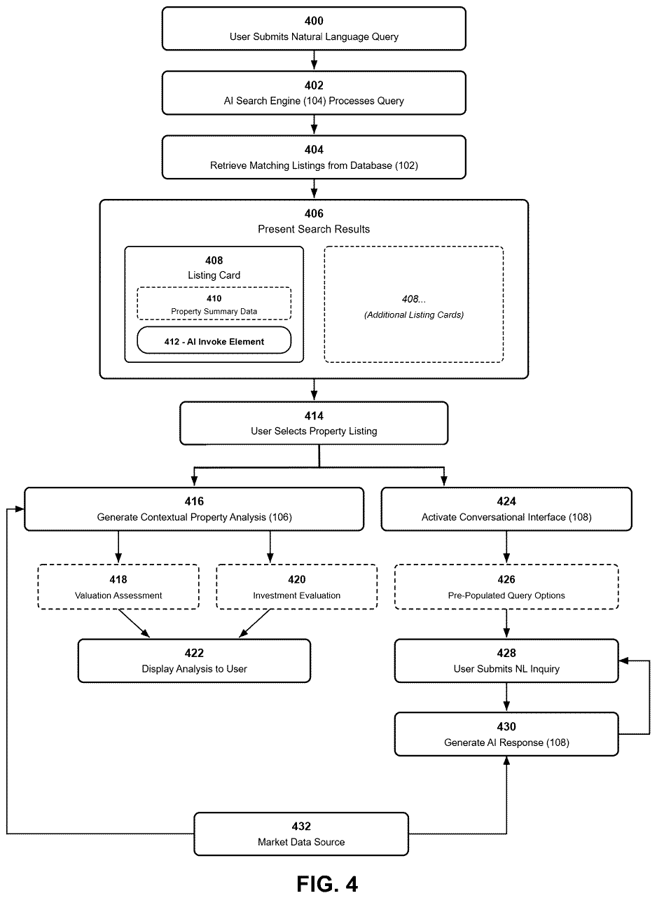

FIG. 4 illustrates an example flowchart depicting a property listing intelligence flow in accordance with an embodiment of the present invention. The flowchart illustrates the integrated operation of the AI search engine 104, the listing intelligence module 106, and the conversational assistant module 108 as a user progresses from initial search through property evaluation and conversational inquiry.

At step 400, a user submits a natural language query through the search interface presented on the consumer user device 114. The natural language query may be expressed as a complete sentence, a phrase, a set of keywords, a conversational request, or any combination thereof, and does not require the user to conform to a predefined syntax or input format.

At step 402, the AI search engine 104 processes the natural language query using a first artificial intelligence model. The first artificial intelligence model parses the query to identify both explicit preferences directly stated by the user and implicit preferences that may be inferred from the query context. The AI search engine 104 extracts structured search parameters including, where applicable, geographic location or area, price range, property type, bedroom and bathroom count, square footage range, proximity to specified features or landmarks, and qualitative characteristics such as neighbourhood character, architectural style, or property condition. The first artificial intelligence model applies contextual interpretation to resolve ambiguous or colloquial references, such as interpreting local neighbourhood names, understanding that “family home” implies multiple bedrooms, proximity to schools, and single-family property type, or recognising that “investment property” implies rental income potential and return-on-investment considerations.

At step 404, the AI search engine 104 retrieves from the property database 102 a set of property listings matching the determined property preferences. The retrieval process translates the extracted structured parameters into database queries, scores retrieved listings by relevance across multiple weighted dimensions, and assembles a ranked result set. The ranking may apply configurable weighting to different preference dimensions based on the specificity and emphasis indicated in the natural language query.

At step 406, the search results are presented to the user as a plurality of listing cards 408. Each listing card 408 comprises property summary data 410 including a representative image, listing price, bedroom and bathroom count, square footage, location, listing status, and time on market. Each listing card 408 further comprises an AI invoke element 412, shown as a selectable button or icon labelled “Ask AI” or similar designation, configured to invoke the listing-level conversational interface for the corresponding property listing. The listing cards 408 may be presented in a list arrangement, a grid arrangement, or a map overlay arrangement with interactive markers at each property location. The search interface concurrently presents filter controls enabling the user to refine the result set through traditional filter-based interaction alongside the natural language search capability.

At step 414, the user selects a property listing from the presented listing cards 408. The selection may occur by tapping or clicking on a listing card 408, by selecting the AI invoke element 412, or by navigating to a property detail page.

At step 416, the listing intelligence module 106 generates a contextual property analysis for the selected property listing using a second artificial intelligence model. The listing intelligence module 106 retrieves property listing data from the property database 102 and market data from the market data source 432, which corresponds to the market data source 118 described with respect to FIG. 1. The contextual property analysis comprises a valuation assessment 418 analysing the listing price relative to comparable properties, evaluating price per square foot, identifying pricing trends, and determining market positioning, and an investment evaluation 420 analysing financial characteristics including return-on-investment potential, rental income projection based on rental rate data for the geographic area, and a risk evaluation identifying both positive factors and negative factors relevant to the property's value and investment potential. The listing intelligence module 106 generates the analysis as a natural language summary synthesising the analytical findings into a format accessible to non-expert users, providing professional-grade intelligence at the point of decision.

At step 422, the contextual property analysis is displayed to the user as a panel, overlay, or dedicated section within the property detail view. The display may include interactive elements enabling the user to explore specific aspects of the analysis in greater detail, ask follow-up questions about the analytical findings, or navigate to the data sources underlying the analysis.

At step 424, the conversational assistant module 108 activates the listing-level conversational interface associated with the selected property listing. The conversational interface may activate automatically upon navigation to the property detail page, upon selection of the AI invoke element 412, or upon explicit user action to open the conversational interface. The conversational assistant module 108 initialises a conversational session scoped to the selected property listing, presents an introductory message identifying itself as a property-specific AI assistant, and displays a set of pre-populated query options 426 dynamically generated based on the property listing data. The pre-populated query options 426 may include options for scheduling a tour, inquiring about neighbourhood characteristics, asking about price history or negotiability, and checking availability, with additional contextual options specific to the property's features, type, or status.

At step 428, the user submits a natural language inquiry through the conversational interface, either by selecting one of the pre-populated query options 426 or by composing an original natural language message.

At step 430, the conversational assistant module 108 generates a response using an artificial intelligence model with access to the property listing data from the property database 102 and market data from the market data source 432. The response is presented as informative, property-specific, conversational natural language prose. The conversational assistant module 108 may, in response to user inquiries, perform actions including scheduling a property tour via the agent interface module 112, generating a financing estimate with estimated monthly payments, and providing neighbourhood information including school ratings, amenity proximity, transportation access, and demographic data. The process iterates through steps 428 and 430 as the user submits follow-up inquiries, enabling a multi-turn conversational exploration of the property.

The market data source 432, which is the same external data provider or providers described as the market data source 118 with respect to FIG. 1, supplies comparable sales data, rental rate data, neighbourhood information, pricing trends, and other market indicators to both the listing intelligence module 106 at step 416 and the conversational assistant module 108 at step 430, ensuring that the contextual property analysis and the conversational responses are informed by the same current market data.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
at least one processor;
at least one memory coupled to said at least one processor, said memory storing instructions that, when executed by said at least one processor, cause the system to:
maintain a property database storing property listing data associated with a plurality of real estate properties;
provide a search interface configured to receive a natural language query from a user and process said natural language query using a first artificial intelligence model to determine property preferences from said natural language query, and to retrieve from said property database a set of property listings matching said property preferences;
generate, for a selected property listing from said set of property listings, a contextual property analysis using a second artificial intelligence model, said contextual property analysis comprising at least a valuation assessment derived from market data and an investment evaluation associated with said selected property listing;
provide a listing-level conversational interface associated with said selected property listing, said conversational interface configured to receive a natural language inquiry from a user concerning said selected property listing and to generate, using an artificial intelligence model, a response to said natural language inquiry based at least in part on said property listing data; and
execute an automated negotiation session between a buyer user and a seller user with respect to said selected property listing, said automated negotiation session comprising:
receiving from said seller user a set of seller-defined negotiation parameters comprising at least a confidential reserve price;
receiving from said buyer user a transaction offer associated with said selected property listing;
generating, using an artificial intelligence model, a counter-offer based at least in part on said seller-defined negotiation parameters, said transaction offer, and market data associated with said selected property listing; and
transmitting said counter-offer to said buyer user without disclosing said confidential reserve price.

2. The system of claim 1, wherein said instructions further cause the system to generate a success probability score indicating a likelihood that said buyer user will accept a counter-offer at or above said confidential reserve price, said success probability score derived at least in part from an analysis of a negotiation pattern of said buyer user during said automated negotiation session.

3. The system of claim 2, wherein said instructions further cause the system to generate a predicted acceptance range indicating a range of transaction values within which said buyer user is predicted to accept an offer, said predicted acceptance range based at least in part on said transaction offer, one or more prior offers received from said buyer user during said automated negotiation session, and comparable transaction data.

4. The system of claim 1, wherein said automated negotiation session comprises a plurality of negotiation rounds, each negotiation round comprising receiving a further transaction offer from said buyer user and generating a further counter-offer, wherein said instructions cause the system to adjust a counter-offer strategy based on a progression of offers received across said plurality of negotiation rounds.

5. The system of claim 2, wherein said instructions further cause the system to present a first interface to said buyer user and a second interface to said seller user, said first interface comprising a conversational negotiation view displaying communications exchanged during said automated negotiation session, and said second interface comprising a strategy dashboard displaying said confidential reserve price, a current transaction offer from said buyer user, a difference between said current transaction offer and said confidential reserve price, a recommended counter-offer, and said success probability score.

6. The system of claim 1, wherein said counter-offer generated by said artificial intelligence model references at least one of a property feature of said selected property listing and a comparable sale associated with a geographic area of said selected property listing.

7. The system of claim 1, wherein said instructions cause the system to employ a plurality of artificial intelligence models comprising at least two distinct model architectures to generate said counter-offer.

8. The system of claim 1, wherein said contextual property analysis further comprises a return-on-investment assessment for said selected property listing based at least in part on historical market data and rental rate data associated with a geographic area of said selected property listing.

9. The system of claim 1, wherein said listing-level conversational interface is further configured to schedule a property tour by interfacing with an agent management module to coordinate availability between said user and a listing agent associated with said selected property listing.

10. The system of claim 1, wherein said listing-level conversational interface presents a plurality of pre-populated query options contextually generated based on said property listing data associated with said selected property listing.

11. The system of claim 1, wherein said search interface is further configured to present, concurrently with said natural language query capability, a filter-based search comprising at least one of a geographic map display with interactive property markers, a price range selector, and property attribute filters.

12. The system of claim 1, wherein said search interface presents said set of property listings as a plurality of listing cards, each listing card comprising property summary data and a selectable element configured to invoke said listing-level conversational interface for a corresponding property listing.

13. The system of claim 1, wherein said instructions further cause the system to provide an agent interface module accessible to a real estate professional user, said agent interface module comprising at least a listing management module for creating and managing property listings in said property database and a lead management module for tracking prospective buyer or tenant users.

14. The system of claim 13, wherein said agent interface module further comprises a performance dashboard displaying at least one of an active listing count, an active lead count, a transaction volume metric, and a goal progress indicator.
